(19) United States
(12) Patent Application Publication
(10) Pub. No.: US 2020/0337944 A1
(43) Pub. Date: Oct. 29, 2020

(54) DEVICE AND METHOD FOR ORAL ADMINISTRATION OF ACTIVE PRINCIPLES

(71) Applicant: Biofarma S.r.l., Mereto di Tomba (IT)

(72) Inventor: Antonella VENUTI, Pagnacco (IT)

(21) Appl. No.: 16/758,260

(22) PCT Filed: Oct. 23, 2018
(86) PCT No.: PCT/IT2018/050204

§ 371 Date: Apr. 22, 2020

(30) Foreign Application Priority Data
Oct. 23, 2017 (IT) 102017000120081
Oct. 5, 2018 (IT) PCT/IT2018/050185

(51) Int. Cl. A61J 1/00

(52) U.S. Cl. CPC A61J 1/00; A61J 1/10

(57) ABSTRACT

The present invention concerns a packing device and a method for the preparation and oral administration of an effervescent powder comprising one or more active principles. In particular, the present invention allows to prepare an effervescent powder comprising one or more active principles using storage chambers physically separated from each other.

### FIELD OF THE INVENTION

Embodiments described here concern a packing device and a method for the preparation and oral administration of a powder comprising one or more active principles.

In particular, embodiments of the device and method described here can be used in the preparation of a powder comprising one or more active principles by means of storage chambers that are physically separated from each other.

### BACKGROUND OF THE INVENTION

It is known that some food supplements and drugs are prepared in solid form of capsules and tablets, which are ingested orally with the help of a small quantity of water. However, this type of oral administration of active principles by means of a capsule or tablet that can be swallowed implies a rather slow absorption kinetics of the active principles into the organism.

Another disadvantage related to the oral ingestion of capsules and tablets that can be swallowed is that it is often difficult and unpleasant, especially for children and older people. It can also be quite difficult even for adults when they are obliged, by a medical prescription, to take several active principles daily, and therefore have to ingest orally several solid capsules per day.

To overcome the problems cited above, alternative forms of dosage of the active principles have been successfully developed.

For example, formulations in the form of granules or powders can be cited, which are solubilized in water. These formulations, packaged in special sachets, are poured into water at the time they are to be taken, and after careful mixing they dissolve, forming a solution containing the desired active principles, which can be easily assimilated even by children and elderly people.

However, one of the most recurrent technical problems in formulations containing active principles in powder is that it is necessary to use components having the same level of solubility in water.

Another form of dosage of active principles which is alternative to swallowing capsules or tablets is represented by the formulation using effervescent tablets, which are highly appreciated by consumers.

Effervescent tablets are prepared in solid form to be dissolved in water just before oral administration. When the tablet is dissolved in water, an effervescent solution is obtained that is rather tasty and pleasant on the palate.

The effervescence of the tablet when immersed in water is caused by a typical acid-base reaction, during which carbon dioxide (CO₂) is released. The substances responsible for the development of carbon dioxide are one or more basic excipients, generally sodium carbonate and/or sodium bicarbonate, and one or more acid excipients, comprising citric acid, tartaric acid or fumaric acid. The effervescent effect develops simultaneously with the solubilization of the solid formulation in the water.

An important advantage of effervescent tablets is that they allow rapid absorption of the active principles, provided they dissolve adequately in water and are present in sufficient dosage. In fact, solid capsules that are ingested whole by the consumer disintegrate and dissolve slowly, resulting in a slow absorption kinetics of the active principles inside the organism. On the contrary, in the case of effervescent tablets, the solid preparation disintegrates and dissolves immediately before oral administration and this confers a significantly faster absorption kinetics.

In support of the above statement, we can cite a study that compares the absorption kinetics of effervescent tablets with that of standard solid capsules, both formulations containing 1000 mg of acetaminophen as the active principle. This study conducted on a large number of patients (over 200) showed that, in the case of effervescent tablets, the average efficacy time of this drug is accelerated by about 15 minutes.

In general, the advantages given by effervescence are correlated to a better wettability in water of the solid preparation. In the case of insoluble or low-solubility active principles, the gases that develop promote the mixing of the solution and a more homogeneous solution of the active principles in water.

However, even effervescent tablets have their negative aspects, such as, for example, an excessive sodium content which is incorporated in the basic excipient (sodium bicarbonate), which is necessary to technically guarantee effervescence. Excess sodium is harmful for hypertensive patients, as well as for elderly people and children. In the latter, in fact, it predisposes to hypertension, while in the elderly, who are more at risk of dehydration, it can lead to a greater accumulation in the blood.

Another disadvantage connected to the solution in water of an effervescent tablet is the uncontrolled movements of the tablet itself while it dissolves, movements which slow down its disintegration time. In fact, under the effect of the bubbles, the tablet oscillates on itself, rises and floats on the liquid, so that the upper surface of the tablet is no longer in intimate contact with water and its solubilization is slowed down.

Furthermore, the oral administration of food supplements using effervescent tablets sometimes provides a multi-dose packaging, that is, a single pack comprising a plurality of tablets side by side with each other: it is clear that this type of packaging cannot guarantee the same protection from environmental humidity, as in the case of a single-dose package.

To summarize, the formulations containing active principles in powder form available on the market have the disadvantage that they must necessarily use powdered components having the same level of solubility in water, and do not have the effervescent effect which helps the patient enjoy taking the product. Effervescent tablets generally have the disadvantage of excessive sodium content to guarantee effervescence and the disadvantage connected to the uncontrolled movements of the tablet while it dissolves, movements that slow down its disintegration time.

Document EP-A-1.859.771 describes a pharmacological device formed by a sachet with separate and sealed double chambers, inside which there is respectively an active opioid principle and a non-steroidal analgesic drug. The purpose is to provide an analgesic “cocktail”, to be used for example in post-operative therapies, which can be prepared immediately and intuitively. The container/sachet is sterile inside, transparent and made of a bilaminate polypropylene (internal side) and PVC (external side).

WO-A-2008/137054 describes a composition for the transmucous administration of polypeptides which includes a biologically active polypeptide, an effervescent excipient component and a bile salt. This document describes effervescent formulations based on citric acid and sodium carbonate and sodium bicarbonate. For example, this document describes how to provide the combined composition respectively of the excipients for effervescence on the one hand and the biologically active polypeptide component and bile salts in solution form on the other hand, or how to provide the components as a tablet.

WO-A-2007/144427 describes a container with multiple compartments separated from each other, provided with a hydraulic connector for the introduction of a fluid (liquid or gas), which can be used for dialysis. The separating walls of the compartments break when a defined internal pressure is reached. The material of the bag can be PVC or PP, a combination of polyethylene, polyamide, polypropylene or PET. For example, this document provides a multilayer with PET on the outside, polyamide intermediate and polyethylene internal.

Document US-A-2015/320712 describes a nutritional composition for patients with gastrostomy tubing and a device for its preparation of the multi-chamber type, provided with a pressurized communicating wall partition system to put the chambers in communication in order to prepare the composition. One of the chambers contains water, one or more other chambers contain a medical composition in solid form. The materials used are polyethylene or polypropylene, mono or multilayer. The material can be made impermeable to gases, and can comprise multilayer structures with aluminum, PVC, PET.

WO-A-87/03809 describes a method for preparing electrolyte solutions and suitable multi-chamber containers.

In the light of the disadvantages cited above, the need is therefore felt to make available a packing device and a method for the preparation and oral administration of formulations comprising one or more active principles.

The Applicant has developed a packing device for powders and an innovative method for the preparation of powders comprising one or more active principles, able to solve the disadvantages of the solid formulations currently on the market, whether powdered or in the form of tablets, possibly effervescent.

One purpose of the present invention is to provide a packing device for the preparation and oral administration of a powder comprising one or more active principles, which is able to allow an efficient and safe storage of the powdered substances before they are mixed and dissolved in water.

Another purpose of the invention is to implement an innovative method for the preparation and oral administration of powders, which contain both active principles and also suitable excipients, possibly able to develop an effervescent effect once the powders have been poured into water.

### SUMMARY OF THE INVENTION

The present invention is set forth and characterized in the independent claims, while the dependent claims describe other characteristics of the invention or variants to the main inventive idea.

In accordance with the above purposes, embodiments concern a packing device for the preparation and oral administration of a powder comprising one or more active principles (P). According to one embodiment, the packing device has multiple storage chambers that are physically separated from each other, and is characterized in that:

a powder comprising one or more active principles (P) and a first excipient (E1) for effervescence is packed in one storage chamber;

a powder comprising one or more active principles (P) and a second excipient (E2) for effervescence is packed in another storage chamber.

In the present description, the expressions “first excipient (E1) for effervescence” and “second excipient (E2) for effervescence” indicate complementary chemical substances in order to ensure the effervescence effect in water, that is, the development of a gas, typically carbon dioxide. It follows that when the first excipient (E1) is a chemical substance with a basic character, the second excipient (E2) is a chemical substance with an acidic character and vice versa, when the first excipient (E1) chemical substance with an acidic character, the second excipient (E2) is a chemical substance with a basic character.

Embodiments of the packing device described here provide to package in separate chambers the two complementary excipients (E1) and (E2) suitable to develop the effervescence effect, while the active principles (P), of the same type or even of a different nature from each other, can be packaged in any storage chamber of the packing device claimed here.

Embodiments of the packing device described here allow to store the two excipients E1 and E2 for effervescence in separate storage chambers, so that no physical interaction takes place between these substances before they are mixed in water. In fact, the storage of substances with an acidic character and basic character E1, E2 in the same chamber could entail a reaction between them, by virtue of the presence of traces of humidity in the air present in the storage chamber.

In accordance with some embodiments, the packaged substances in powder form having the function of active principles (P) can be pharmacological substances, vitamins, minerals, probiotics, amino acids, trace elements, antioxidants and plant extracts.

At the moment the active principles (P) listed above are taken, as will be explained with reference to FIG. 1, the packing device can be opened in correspondence with the storage chambers, in order to allow the packed powder to exit.

Pouring the powder containing the active ingredients (P), the first excipient (E1), and the second excipient (E2) into water, promotes a better dispersion of the substances (P) in water compared to the formulations available on the market. This happens because the wettability is accelerated, thanks to the contribution given by the effervescence generated by the reaction between the two excipients (E1) and (E2) in water.

Consequently, embodiments described here advantageously combine the advantages of a solid powder formulation with the effervescence effect typical of effervescent tablets.

Other embodiments concern a method to prepare a powder comprising one or more active principles (P) using storage chambers physically separated from each other, said method comprising:

disposing in one storage chamber a powder comprising said active principles (P) and a first excipient (E1) for effervescence;

disposing in another storage chamber a powder comprising said active principles (P) and a second excipient (E2) for effervescence;

with the condition that when said first excipient (E1) has a basic nature, said second excipient (E2) has an acidic nature, or vice versa.

The method described above has the considerable advantage of overcoming the chemical-physical incompatibility of the excipients responsible for the effervescent effect, by means of a packing device provided with multiple storage chambers.

Moreover, embodiments of the method described here allow to overcome one of the most recurrent problems in the powder formulation containing active ingredients, that is, the need to use powdered components having a comparable water solubility. In fact, the effervescent effect generated by the reaction between the excipients E1 and E2 overcomes this disadvantage, since the release of CO₂ into the water increases the wettability of the individual components and their mixing, and ultimately, the homogeneity of the suspension obtained.

In some embodiments, which can be combined with all the embodiments described here, the packing device comprises closing welds defining a line of folding and/or tearing around a longitudinal axis and delimiting the two storage chambers physically separated from each other.

Other embodiments concern a packing device for the preparation and oral administration of an effervescent powder comprising one or more active ingredients. According to one embodiment, the packing device is a closed stick-pack having only three welds and formed by a pipe made of poly-coupled polymer-metal material on which there are two transverse welds, an upper and a lower one, and a central separation weld defining a folding line around a longitudinal axis. The separation weld delimits two storage chambers physically separated from each other, in which:

in one storage chamber a powder is packaged comprising one or more active principles and a first excipient for effervescence;

in another storage chamber a powder is packaged comprising one or more active principles and a second excipient for effervescence.

Other embodiments concern a method to prepare an effervescent powder comprising one or more active principles (P) using storage chambers physically separated from each other. The method comprises making available a packing device in accordance with the present description, wherein in one storage chamber there is a powder comprising the active principles (P) and a first excipient for effervescence and in another storage chamber there is a powder comprising the active principles and a second excipient for effervescence;

with the condition that when the first excipient has a basic nature, the second excipient has an acidic nature, or vice versa.

Other embodiments concern a method to prepare a solution for oral administration comprising one or more active principles using a packing device with storage chambers physically separated from each other, wherein:

in one storage chamber there is a powder comprising the active principles and a first excipient for effervescence;

in another storage chamber there is a powder comprising the active principles and a second excipient for effervescence;

the method comprising:

opening the storage chambers and mixing in water the powders contained in the storage chambers with consequent development of effervescence due to the reaction between the first excipient and the second excipient;

obtaining a solution of the active principles in water suitable for oral administration.

Furthermore, other embodiments concern a method for packaging a composition of effervescent powder comprising one or more active ingredients. According to one embodiment, the method provides to:

make available a poly-coupled polymer-metal material;

make closing welds defining a fold and/or tear line around a longitudinal axis and delimiting two physically separate storage chambers;

introduce into a storage chamber a powder comprising one or more active ingredients and a first excipient for effervescence;

introduce into another storage chamber a powder comprising one or more active ingredients and a second excipient for effervescence;

make a closing weld to close said two storage chambers, obtaining a closed multi-chamber package.

Furthermore, other embodiments concern a packaging method of an effervescent powder comprising one or more active principles. According to one embodiment the method provides to:

make available a pipe made of poly-coupled polymer-metal material;

make a first lower transverse closing weld and a second central separation weld defining a folding line around a longitudinal axis delimiting two physically separated storage chambers;

introduce into a storage chamber a powder comprising one or more active principles and a first excipient for effervescence;

introduce into another storage chamber a powder comprising one or more active principles and a second excipient for effervescence;

make a third upper transverse closing weld to close the two storage chambers and obtain a closed multi-chamber stick-pack.

Furthermore, other embodiments concern a packing device for the preparation and oral administration of a powder composition comprising one or more active ingredients. According to one embodiment, the packing device is provided with two storage chambers physically separated from each other, in which:

in one storage chamber a powder is packaged comprising one or more active ingredients and a possible first excipient;

in another storage chamber a powder is packaged comprising one or more active ingredients and a possible second excipient.

Furthermore, other embodiments concern a packing device for the preparation and oral administration of a powdered composition comprising one or more active principles. According to one embodiment, the packing device is a closed stick-pack having only three welds and formed by a pipe made of poly-coupled polymer-metal material on which there are two transverse closing welds, upper and lower, and a central separation weld defining a folding line around a longitudinal axis. The separation weld delimits two storage chambers physically separated from each other, in which:

in one storage chamber a powder is packaged comprising one or more active principles and a possible first excipient;

in another storage chamber a powder is packaged comprising one or more active principles and a possible second excipient.

Furthermore, other embodiments concern a method for packaging a powder composition comprising one or more active ingredients (P). According to one embodiment, the method provides to:

make available a poly-coupled polymer-metal material;

make closing welds defining a fold and/or tear line around a longitudinal axis and delimiting two physically separate storage chambers;

introduce into one storage chamber a powder comprising one or more active ingredients and a possible first excipient;

introduce into another storage chamber a powder comprising one or more active ingredients and a possible second excipient;

make a closing weld to close said two storage chambers obtaining a closed multi-chamber package.

Furthermore, other embodiments concern a method for packaging a powdered composition comprising one or more active principles. According to one embodiment, the method provides to:

make available a pipe of poly-coupled polymer-metal material;

make a first lower transverse closing weld and a second central separation weld defining a folding line around a longitudinal axis delimiting two physically separated storage chambers;

introduce into a storage chamber a powder comprising one or more active principles and a possible first excipient;

introduce into another storage chamber a powder comprising one or more active principles and a possible second excipient;

make a third upper transverse closing weld to close the two storage chambers and obtain a closed multi-chamber stick-pack.

These and other aspects, characteristics and advantages of the present disclosure will be better understood with reference to the following description, drawings and attached claims. The drawings, which are integrated and form part of the present description, show some forms of embodiment of the present invention, and together with the description, are intended to describe the principles of the disclosure.

The various aspects and characteristics described in the present description can be applied individually where possible. These individual aspects, for example aspects and characteristics described in the attached dependent claims, can be the object of divisional applications.

It is understood that any aspect or characteristic that is discovered, during the patenting process, to be already known, shall not be claimed and shall be the object of a disclaimer.

### BRIEF DESCRIPTION OF THE DRAWINGS

These and other characteristics of the present invention will become apparent from the following description of some embodiments, given as a non-restrictive example with reference to the attached drawings wherein:

FIG. 1 shows a front section view of a packing device with two physically separated storage chambers, which are used to store, in powder form, active principles and excipient substances (E1) and (E2) as defined above and subsequently mix them;

FIG. 2 shows a packing device in accordance with embodiments described here;

FIG. 3 shows an operating sequence to make a packing device in accordance with embodiments described here;

FIG. 4 shows a packing device in accordance with embodiments described here;

FIG. 5 shows a packing device in accordance with other embodiments described here;

FIG. 6 shows a packing device according to other embodiments described here;

FIG. 7 shows a packing device according to other embodiments described here;

FIG. 8 shows a packing device according to other embodiments described here.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We will now refer in detail to the various embodiments of the invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall comprise all such modifications and variants.

Before describing these embodiments, we must also clarify that the present description is not limited in its application to details of the construction and disposition of the components as described in the following description using the attached drawings. The present description can provide other embodiments and can be obtained or executed in various other ways. We must also clarify that the phraseology and terminology used here is for the purposes of description only, and cannot be considered as limitative.

We must point out that, in the embodiments described here, the term “effervescent” refers to mixtures of solid substances, generally based on sodium bicarbonate or other suitable basic compounds and a substance with an acidic character, which in contact with water cause an instantaneous development of gas, generally carbon dioxide.

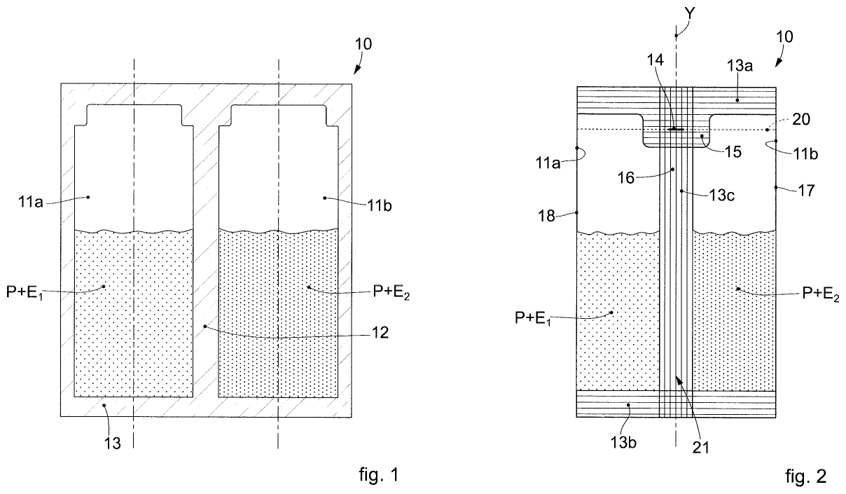

FIGS. 1, 2, 3, 4, 5, 6, 7 and 8 are used to describe embodiments of a packing device (10) with multiple chambers (11a, 11b) in accordance with the present description, particularly advantageous for packaging and storing powdered substances comprising one or more active principles (P), so that they can be administered orally. Typically, the packing device (10) according to the embodiments described here using FIGS. 1, 2, 3, 4 and 5 is disposable and must be torn or broken irreversibly so that its contents can be administered.

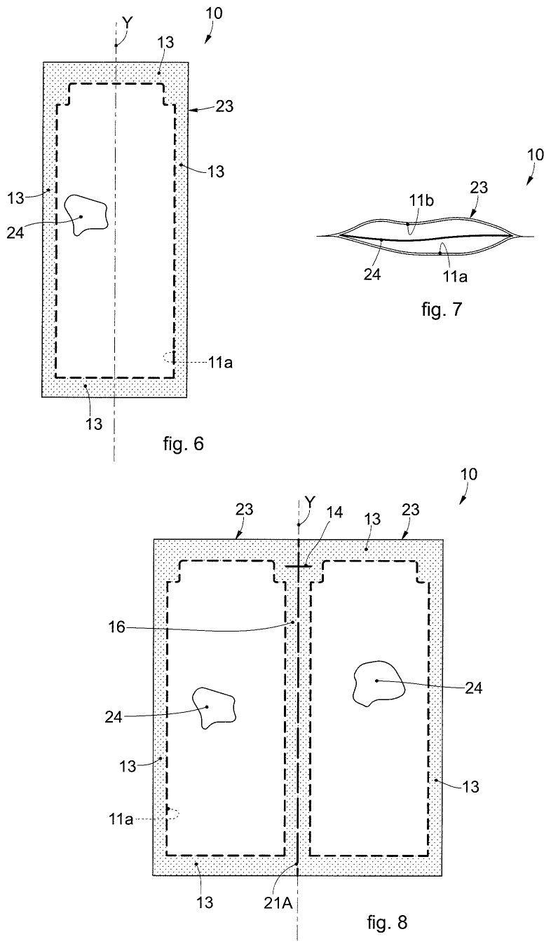

In particular, FIG. 1 is used to describe non-restrictive embodiments of the packing device (10), which can be combined for example with the embodiments described using FIGS. 2, 3, 4 and 5, in which there are two storage chambers (11a, 11b) physically separated from each other by an intermediate sealing or welding strip (12) (see FIG. 1), or by a central separation weld (13c) (see FIGS. 2, 3, 4 and 5), the function of which is to prevent reciprocal contact of the powders contained in the storage chambers (11a) and (11b) respectively. Instead, in the embodiments shown in FIGS. 6, 7 and 8, the two storage chambers (11a, 11b) can be inside a respective sachet (“3) and be separated by a division or a membrane (24).

In embodiments described using FIG. 1, and combinable and applicable for example to the embodiments described using FIGS. 2, 3, 5, 6, 7 and 8, the packing device (10) can be used to produce an effervescent formulation. In these embodiments, therefore, the storage chamber (11a) is partly filled with a powder comprising one or more active principles (P) and a first excipient (E1) for effervescence, as previously defined. On the contrary, the storage chamber (11b) is partly filled with a powder comprising one or more active principles (P) and a second excipient (E2) for effervescence.

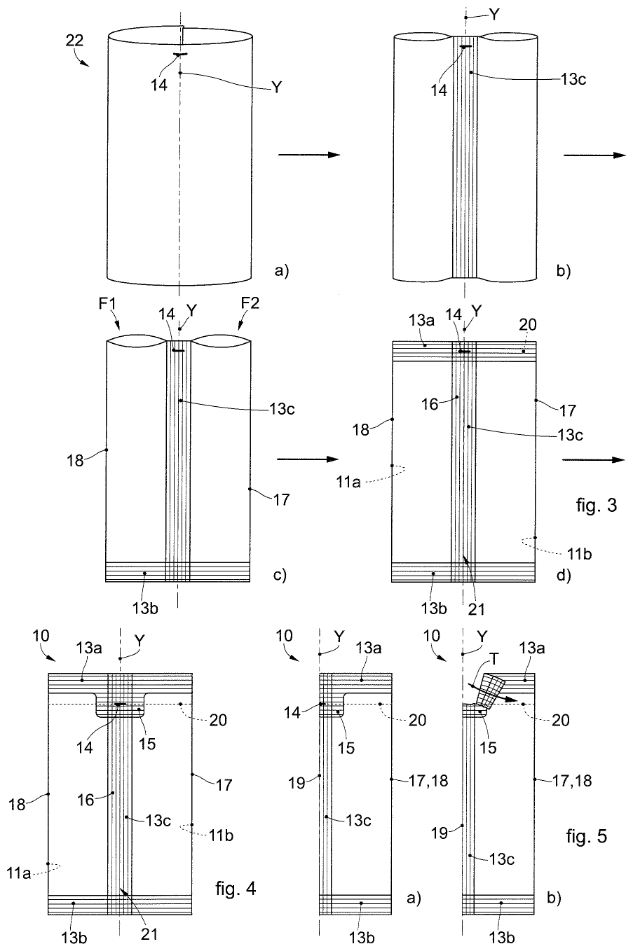

In embodiments described using FIGS. 3, 4, 5, 6, 7 and 8, on the contrary, the packing device (10) can be used to produce a non-effervescent formulation divided into two parts in the two storage chambers (11a, 11b) and to be taken simultaneously. For example, to package prebiotic and/or probiotic powdered compositions and possibly containing plant extracts and digestive enzymes, suitably divided in the two storage chambers (11a, 11b) and to be taken simultaneously. In these embodiments, therefore, the storage chamber (11a) is partly filled with a powder comprising one or more active principles (P) and a possible first excipient (E1). On the contrary, the storage chamber (11b) is partly filled with a powder comprising one or more active principles (P) and a possible second excipient (E2).

Below we describe alternative embodiments of the present description, which can be combined and applied to the embodiments described using FIGS. 1, 2, 3, 5, 6, 7 and 8, in the case where the packing device (10) is used to make an effervescent formulation. In a first case, a first excipient (E1) with a basic character can be disposed in the first storage chamber (11a) and a second excipient (E2) with an acidic character in the second storage chamber (11b). According to an alternative embodiment, a first excipient (E1) with an acidic character can be disposed in the first storage chamber (11a) and a second excipient (E2) with a basic character in the second storage chamber (11b). Both of these alternative embodiments are effective to obtain the advantages of the invention described above.

In possible embodiments, combinable and applicable to the embodiments described using FIGS. 1, 2, 3, 5, 6, 7 and 8, in the packing device (10) the excipients (E1) or (E2) of a basic nature can comprise, by way of non-restrictive example, carbonates and/or bicarbonates, in particular sodium, magnesium, potassium carbonates or bicarbonates.

In possible embodiments in which an effervescent formulation is provided, the excipients (E1) or (E2) with an acidic nature can comprise, by way of non-restrictive example, citric acid, malic acid, tartaric acid, ascorbic acid, fumaric acid or adipic acid. Other possible acids can be, for example, cream of tartar or acid phosphate.

As regards the weight ratio between the powders of the excipients with an acidic nature and those with a basic nature, this is generally between 1.0 and 2.2, preferably between 1.4 and 2.0.

The excipients functional to effervescence (E1), (E2) are inserted in the powdered preparation with percentages from 14% to 100% in weight for the carbonates and from 16% to 100% in weight for the acids, which must be calibrated as a function of the desired greater or lesser effervescent effect.

In the embodiments where it is provided to use the packing device 10 for non-effervescent formulations as described above, the excipients E1, E2 can be of another nature, suitable for the specific purpose for which the formulation is provided.

On the contrary, the content of the active principles (P) in the embodiments described in FIGS. 1, 2, 3, 4, 5, 6, 7 and 8, varies from formulation to formulation according to the physiological activity attributed to the product to be administered orally.

With regard to the grain size of the powdered substances (P, E1, E2) inserted inside the storage chambers (11a, 11b), this is generally comprised between 75 and 800 μm. However, for powders of excipients E1, E2 with effervescent effect, it is preferred to use a slightly lower particle size comprised between 75 and 500 μm.

In some particular formulations, such as the preparation of magnesium-based supplements, magnesium carbonate, besides having the function of active principle (P), helps to generate the effervescence effect in contact with water, as it is simultaneously an excipient substance (E1 or E2) with a basic character.

An analogous case concerns the preparation of vitamin C supplements, in which the ascorbic acid, in addition to having the function of active principle (P), helps to generate effervescence when put in contact in water, as it is simultaneously an excipient substance (E1 or E2) with acidic character.

FIGS. 1, 2, 3, 4 and 5 are used to describe embodiments combinable and applicable to the other embodiments described here, of a packing device (10) which comprises closing welds defining a folding and/or tear line around a longitudinal axis (Y) and delimiting said two storage chambers (11a, 11b) physically separated from each other.

The packing device (10) described using FIG. 1, 2, 3, 4, 5, 6, 7 or 8 can be made by superimposing a multilayer laminate (PET-ALU-PE) which is suitably folded and formed in a machine, so as to generate the formation of internal chambers (11a, 11b) physically separated from each other. This material is advantageously non-transparent, so as to protect the contents from light radiations which could damage or ruin them.

To this purpose, with reference to the embodiments described using FIG. 1, the two laminates with three layers of the composition as indicated are sealed together so as to generate both an intermediate seal or weld (12) separating the two storage chambers (11a, 11b), and also a peripheral seal (13) along the entire edge of the packing device (10). The peripheral seal (13) can be formed for example by five welding segments, of which four perimeter welds and a central weld along a longitudinal axis Y, which separates the two storage chambers (11a, 11b). This description can be applied, suitably modified according to the type of variant, also for the embodiments shown in FIG. 2, 3, 4, 5, 6, 7, or 8.

Advantageously, moreover, the packaging can be carried out in a controlled atmosphere, so as not to contaminate or alter the state of the ingredients of the composition. In particular, packaging in a controlled atmosphere is such that the residual oxygen content in the package is less than 1%, thus limiting the oxidative effect on the substances present.

As explained, the packing device (10) made in accordance with the present description is suitable to be used in a method for the preparation and oral administration of a powder comprising one or more active principles (P).

To perform the oral administration of the active principles (P) it is necessary to open the storage chambers (11a, 11b) in order to extract the powders contained therein, and then pour them into a small quantity of water in order to obtain a solution of the powders in water. Mixing the powders in water will promote their solution, together with the effect of effervescence generated by the reaction between the excipients with a basic and acidic nature.

Therefore, other embodiments, combinable and applicable to the embodiments described using FIGS. 1, 2, 3, 4, 5, 6, 7, and 8, concern a method for the preparation of a solution comprising one or more active principles (P) by means of a packing device (10) according to the present description, provided with storage chambers (11a, 11b) physically separated from each other, the method comprising:

disposing in a storage chamber (11a) a powder comprising the active principles (P) and a first excipient (E1) for effervescence;

disposing in a storage chamber (11b) a powder comprising the active principles (P) and a second excipient (E2) for effervescence;

mixing in water the powders contained in the storage chambers (11a, 11b) with consequent development of effervescence due to the reaction between the first excipient (E1) and the second excipient (E2);

obtaining a solution of the active principles (P) in water suitable for oral administration.

FIGS. 2, 3, 4 and 5 are used to describe other embodiments which can be combined and applicable to the other embodiments described here, of a packing device (10) for the preparation and oral administration of an effervescent powder comprising one or more active principles (P). According to some embodiments, the packing device (10) is a closed stick-pack having only three welds, or seals, (13a, 13b, 13c) and formed by a tube (22) made of poly-coupled polymer-metal laminated material on which there are two transverse closing welds or seals, upper (13a) and lower (13b), and a central separation weld or seal (13c) defining a folding line (21) around a longitudinal axis (Y) , the separation weld (13c) delimiting two storage chambers (11a, 11b) physically separated from each other, wherein:

in one storage chamber (11a) a powder is packaged comprising one or more active principles (P) and a first excipient (E1) for effervescence;

in another storage chamber (11b) a powder is packaged comprising one or more active principles (P) and a second excipient (E2) for effervescence.

In particular, the packing device (10) according to the embodiments described here using FIGS. 2, 3, 4 and 5 has no welds or seals along the external lateral edges, since only the above three welds or seals (13a, 13b, 13c) are provided.

Again, once it has been closed with the two transverse closing welds or seals, upper (13a) and lower (13b), the packing device (10) according to the embodiments described here using FIGS. 1, 2, 3, 4 and 5 has no apertures, inlets, valves, connectors or similar entrance or exit elements for a liquid or fluid and the only way to open it is to tear one end thereof along a tear line 20 as described in more detail hereafter. Consequently, the packing device (10) according to the embodiments described here using FIGS. 1, 2, 3, 4 and 5 is the disposable type and cannot be reused. This description can also be applied to the embodiments shown in FIGS. 6, 7 and 8.

In some embodiments, the two storage chambers (11a, 11b) have a common central joining side (16) along the longitudinal axis (Y) and the folding line (21) and two respective external lateral edges (17, 18).

In some embodiments, one or the other of the transverse closing welds or seals, upper (13a) or lower (13b), has a protruding nose welding portion (15) facing toward the inside and disposed centrally in correspondence with the longitudinal axis (Y).

In some embodiments, combinable with all the embodiments described using FIGS. 1 to 8, the packing device (10) comprises a pre-cut (14). In the embodiments described using FIGS. 1, 2, 3, 4 and 5, the pre-cut (14) is disposed along the longitudinal axis (Y) and is transverse to it. The pre-cut (14) is configured to define a tear-off lead-in to open the storage chambers (11a, 11b) along a transverse tear line (20), only indicated schematically in broken lines in FIGS. 2, 3 part d, 4 and 5, and which can possibly also be present in the embodiments described using FIG. 1. In the embodiments described using FIGS. 1, 2, 3, 4, 5 and 8, the tear line (20) is transverse to the longitudinal axis (Y).

In possible implementations, the pre-cut (14) is made astride the joining side (16) (see FIG. 2, FIG. 3, part d, FIG. 4 for example).

In some embodiments, the pre-cut (14) is made as an incision passing from side to side through the material of the pipe (22).

In some embodiments, the pre-cut (14) is disposed inside the welding region of one or the other of the transverse closing welds, upper (13a) or lower (13b) (see FIGS. 2, 3 and 4 for example).

In some embodiments, the pre-cut (14) is provided in the protruding nose welding portion (15) (see FIGS. 2, 4 and 5 for example).

In some embodiments, combinable with all the embodiments described using FIGS. from 1 to 5, the two storage chambers (11a, 11b) can be reciprocally overlapped by rotation around the folding line (21) along the longitudinal axis (Y) to assume an overlapping condition (see FIG. 5, parts a) and b) for example), laterally delimited on one side by a joining edge (19) defined along the common joining side (16) between the two storage chambers (11a, 11b) along the longitudinal axis (Y) and on an opposite side by an overlapping edge of the respective external lateral edges (17, 18) of the two storage chambers (11a, 11b), in which the overall transverse bulk of the packing device is substantially halved.

In some embodiments, in the overlapping condition (see FIG. 5, part a) for example) the pre-cut (14) is astride the joining edge (19) so that by tearing the pre-cut (14) both the two storage chambers (11a, 11b) are simultaneously opened along the tear line (20) (see FIG. 5, part b for example). Advantageously, in this way, with a single tear-off movement (see arrow T in FIG. 5, part b), the consumer can automatically open both the two storage chambers 11a, 11b simultaneously.

In some embodiments, combinable and applicable to all the embodiments described here, the material of the pipe (22) is a polyethylene-aluminum-polyethylene terephthalate (PE-ALU-PET) poly-coupled laminate, in which the polyethylene constitutes an innermost layer facing toward the inside of the storage chambers (11a, 11b), the aluminum constitutes an intermediate layer and the polyethylene terephthalate constitutes an outermost layer of the material. This material is advantageously non-transparent, so as to protect the contents from light radiations which could damage or ruin them.

In embodiments, a method is also provided for packaging an effervescent powder comprising one or more active ingredients (P). The method provides to:

make available a poly-coupled polymer-metal material;

make closing welds defining a fold and/or tear line around a longitudinal axis (Y) and delimiting two storage chambers (11a, 11b) physically separated from each other;

introduce into one storage chamber (11a) a powder comprising one or more active ingredients (P) and a first excipient (E1) for effervescence;

introduce into another storage chamber (11b) a powder comprising one or more active ingredients (P) and a second excipient (E2) for effervescence;

make a closing weld to close said two storage chambers (11a, 11b), obtaining a closed multi-chamber package.

FIG. 3 is also used to describe embodiments of a method for packaging an effervescent powder comprising one or more active principles (P), which can be combined with the embodiments described using FIGS. 2, 4 and 5. In these embodiments, the method provides to:

make available a pipe (22) made of poly-coupled polymer-metal laminated material (see FIG. 3, part a);

make a first lower transverse closing weld, or seal, (13b) (see FIG. 3, part b) and a second central weld or seal (13c) defining a folding line around a longitudinal axis (Y) delimiting two storage chambers (11a, 11b) physically separated from each other (see FIG. 3, part c);

introduce into a storage chamber (11a) a powder comprising one or more active principles (P) and a first excipient (E1) for effervescence (as indicated by the arrow F1 in FIG. 3, part c);

introduce into another storage chamber (11b) a powder comprising one or more active principles (P) and a second excipient (E2) for effervescence (as indicated by the arrow F2 in FIG. 3, part c);

make a third upper transverse closing weld, or seal (13a) to close the two storage chambers (11a, 11b) and obtain a closed multi-chamber stick-pack (see FIG. 3, part d).

In other embodiments, the method comprises making a pre-cut (14) disposed along the longitudinal axis (Y) and transverse thereto and configured to define a tear-off lead-in to open the storage chambers (11a, 11b) along a tear line (20) transverse to the longitudinal axis (Y) (see FIG. 5, part b for example). For example, the pre-cut (14) can be a pre-working already present on the material of the pipe (22), as shown for example in FIG. 3, part a, or can be made during the various intermediate operations or even after the packing device (10) has been permanently closed.

In some embodiments, which can be combined and applied to the embodiments described using FIGS. 2, 3 and 4, the pipe (22) can be obtained from a coil of suitable material, which is unwound and conveyed and shaped suitably to close in a tubular form, overlapping along two peripheral flaps. After this, the method proceeds as stated above, to make the first lower transverse closing weld, or seal (13b) and the second central separation weld or seal (13c). There is nothing to prevent making first of all the second central separation weld or seal (13c), and after that the first lower transverse closing weld, or seal (13b). At this point, the storage chambers (11a, 11b) are formed separately from each other and can be filled with the ingredients (P, E1, D2) of the formulation, after which the third upper transverse closing weld, or seal (13a) is made, to permanently close the two storage chambers (11a, 11b) and obtain a closed multi-chamber stick-pack. As we said, the pre-cut (14) can already be present on the coil wound around the reel that feeds the material of the pipe (22) (see FIG. 3, part a for example), or can be made later, either during intermediate operations, or at the end of processing, when the packing device (10) has been completely closed.

In other embodiments, the packing device (10) can also be used for the preparation and oral administration of a powdered composition comprising one or more active principles (P), which is not necessarily of the effervescent type, as described above (see FIGS. 3, 4 and 5 for example). In these embodiments, the packing device (10) can be a closed stick-pack having only three welds, or seals, (13a, 13b, 13c) and formed from a pipe (22) made of poly-coupled polymer-metal laminated material on which there are two closing welds or seals, upper (13a) and lower (13b), and a central separation weld or seal (13c) defining a folding line (21) around a longitudinal axis (Y), the separation weld (13c) delimiting two storage chambers (11a, 11b) physically separated from each other, in which:

in one storage chamber (11a) a powder is packaged comprising one or more active principles (P) and a possible first excipient (E1);

in another storage chamber (11b) a powder is packaged comprising one or more active principles (P) and a possible second excipient (E2).

A method for packaging a powder composition comprising one or more active ingredients (P) is also provided. The method provides to:

make available a poly-coupled polymer-metal material;

make closing welds defining a fold and/or tear line around a longitudinal axis (Y) and delimiting two storage chambers (11a, 1 lb) physically separated from each other;

introduce into one storage chamber (11a) a powder comprising one or more active ingredients (P) and a possible first excipient (E1);

introduce into another storage chamber (11b) a powder comprising one or more active ingredients (P) and a possible second excipient (E2);

make out a closing weld to close said two storage chambers (11a, 11b), obtaining a closed multi-chamber package.

A method is also provided for packaging a powdered composition comprising one or more active principles (P), which is not necessarily of the effervescent type (see FIGS. 3, 4 and 5 for example). The method provides to:

make available a pipe (22) made of poly-coupled polymer-metal laminated material;

make a first lower transverse closing weld, or seal (13b) and a second central separation weld, or seal (13c) defining a folding line around a longitudinal axis (Y) delimiting two storage chambers (11a, 11b) physically separated from each other;

introduce into a storage chamber (11a) a powder comprising one or more active principles (P) and a possible first excipient (E1);

introduce into another storage chamber (11b) a powder comprising one or more active principles (P) and a possible second excipient (E2);

make a third upper transverse closing weld, or seal (13a) to close the two storage chambers (11a, 11b) and obtain a closed multi-chamber stick-pack.

In accordance with other embodiments described using FIGS. 6, 7 and 8, the packing device (10) can provide that the two storage chambers (11a, 11b) are made in a single sachet (23). Also in these embodiments, a pre-cut (14) and a possible transverse tear line (20) can be provided. In these embodiments, the welds (13) delimit the sachet (23) peripherally.

In possible implementations, the two storage chambers (11a, 11b) made in a single sachet (23) are separated by a transverse division or membrane (24) inside the sachet (23). The division or membrane (24) is configured to keep the active ingredients (P) and the first excipient (E1) and the second excipient (E2) separated. By opening the upper part of the sachet (23) by tearing, the upper part of the division or membrane (24) is also automatically torn, so that it is possible to deliver the contents of the two storage chambers (11a, 11b).

According to a possible variant embodiment, described using FIGS. 6 and 7, the packing device (10) comprises a single sachet (23), that is, it consists of a single sachet (23).

According to another variant embodiment, described using FIG. 8, the packing device (10) comprises two or more sachets (23) connected to one another, for example by a tear line (21a). For example, two, three, four or even more than four connected sachets can be provided. The sachets (23) each contain, in the respective two storage chambers (11a, 11b), an overall dose or quantity of product to be taken, which dose or quantity is composed by combining or associating the contents of the two storage chambers (11a, 11b) once the sachet has been opened (23). In this variant embodiment, the welds (13) delimit the sachet (23) peripherally and also define the joining side (16) between the sachets (23) themselves along the longitudinal axis (Y). Along the longitudinal axis (Y) a folding (21) and/or tear line (21a) can also be made. For example, if it is a tear line (21a), the two sachets (23) can be separated from each other and opened individually, and also at different times. By tearing open the upper part of a sachet (23), the upper part of the division or membrane (24) is also automatically torn, so that it is possible to deliver the contents of the two storage chambers (11a, 11b). This, for example, can be obtained by means of the pre-cut (14), and it is therefore possible to easily use or take the contents of the two storage chambers (11a, 11b) separated by the division or membrane (24) of a single sachet (23).

In some embodiments, therefore, a method can be provided for packaging an effervescent powder comprising one or more active ingredients (P), which comprises:

making available a poly-coupled polymer-metal material and a division or membrane (24);

making closing welds to define at least one sachet (23) delimiting internally two storage chambers (11a, 11b) physically separated from each other by the division or membrane (24) transversely inside said sachet (23);

introducing into one storage chamber (11a) a powder comprising one or more active ingredients (P) and a first excipient (E1) for effervescence;

introducing into another storage chamber (11b) a powder comprising one or more active ingredients (P) and a second excipient (E2) for effervescence;

making a closing weld to close the two storage chambers (11a, 11b), obtaining a closed multi-chamber package.

As described above, the embodiments described using FIGS. 6, 7 and 8 can also be used or implemented to make or supply an effervescent product, in which case, as we said, the first excipient (E1) and the second excipient (E2) are for effervescence. Or alternatively the embodiments described using FIGS. 6, 7 and 8 can be used to make or supply a powdered product, also not effervescent, and in this case the first excipient (E1) and the second excipient (E2) can be optional and, if provided, not necessarily for effervescence.

It is clear that, although the packing device (10) and the method for the preparation and oral administration of a powder according to the present invention have been described with reference to the embodiments described in the attached figures, a person of skill in the art shall certainly be able to make many other equivalent forms of the packing device (10) having the characteristics set forth in the claims, and hence all coming within the field of protection defined thereby.

In the following claims, the sole purpose of the references in brackets is to facilitate reading: they must not be considered as restrictive factors with regard to the field of protection claimed in the specific claims.

1. Packing device (10) for the preparation and oral administration of an effervescent powder comprising one or more active principles (P), wherein said packing device (10) provided with two storage chambers (11a, 11b) physically separated from each other, wherein:
a powder comprising one or more active principles (P) and a first excipient (E1) for effervescence is packed in one storage chamber (11a);
a powder comprising one or more active principles (P) and a second excipient (E2) for effervescence is packed in another storage chamber (11b).

2. Packing device (10) as in claim 1, wherein it comprises closing welds defining a line of folding and/or tearing around a longitudinal axis (Y) and delimiting said two storage chambers (11a, 11b) physically separated from each other.

3. Packing device (10) as in claim 1, wherein said packing device (10) is a closed stick-pack having only three welds (13a, 13b, 13c) and formed by a pipe (22) of poly-coupled polymer-metal material on which there are two transverse closing welds, upper (13a) and lower (13b), and a central separation weld (13c) defining a folding line (21) around a longitudinal axis (Y), said separation weld (13c) delimiting said two storage chambers (11a, 11b).

4. Packing device (10) as in claim 2, wherein said two storage chambers (11a, 11b) have a common central joining side (16) along said longitudinal axis (Y) and said folding line (21) and two respective external lateral edges (17, 18).

5. Packing device (10) as in claim 3, wherein one or the other of said transverse closing welds, upper (13a) or lower (13b), has a protruding nose welding portion (15) facing toward the inside and disposed centrally in correspondence with said longitudinal axis (Y).

6. Packing device (10) as in claim 2, wherein it comprises a pre-cut (14) disposed along said longitudinal axis (Y) and transverse thereto, and configured to define a tear-off lead-in in order to open said chambers along a tear line (20) transverse to said longitudinal axis (Y).

7. Packing device (10) as in claim 6, wherein said pre-cut (14) is made astride said joining side (16).

8. Packing device (10) as in claim 6, wherein said pre-cut (14) is made as a through incision from side to side through the material of said pipe (22).

9. Packing device (10) as in claim 6, wherein said pre-cut (14) is disposed inside the welding area of one or the other of said transverse closing welds, upper (13a) or lower (13b).

10. Packing device (10) as in claim 6, wherein said pre-cut (14) is provided in said protruding nose welding portion (15).

11. Packing device (10) as in claim 4, wherein said two storage chambers (11a, 11b) can be positioned on top of each other by means of rotation around said folding line (21) along said longitudinal axis (Y), in order to assume an overlapping condition, laterally delimited on one side by a joining edge (19) defined along a common joining line (16) between said two storage chambers (11a, 11b) along the longitudinal axis (Y) and on an opposite side by an overlapping edge of the respective external lateral edges (17, 18) of said two storage chambers (11a, 11b), wherein the overall transverse bulk of said packing device is substantially halved.

12. Packing device (10) as in claim 11, wherein in said overlapping condition said pre-cut (14) is astride said joining edge (19) so that, by tearing said pre-cut (14), the simultaneous opening of both of said two storage chambers (11a, 11b) is determined along said tear line (20).

13. Packing device (10) as in claim 1, wherein said material of said pipe (22) is a polyethylene-aluminum-polyethylene terephthalate (PE-ALU-PET) poly-coupled laminate, wherein the polyethylene constitutes a more internal layer facing toward the inside of said storage chambers (11a, 11b), the aluminum constitutes an intermediate layer and the polyethylene-terephthalate constitutes a more external layer of said material.

14. Packing device (10) as in claim 1, wherein when said first excipient (E1) has a basic nature, said second excipient (E2) has an acidic nature, or vice versa.

15. Packing device (10) as in claim 1, wherein said storage chambers (11a, 11b) are physically separated from each other by an intermediate sealing strip (12).

16. Packing device (10) as in claim 1, wherein said active principles (P) comprise one or more of pharmacological substances, vitamins, minerals, probiotics, amino acids, trace elements, antioxidants and plant extracts.

17. Packing device (10) as in claim 1, wherein the excipients (E1 or E2) of a basic nature comprise carbonates and/or bicarbonates of sodium, magnesium, potassium.

18. Packing device (10) as in claim 1, wherein the excipients (E1 or E2) of an acidic nature comprise citric acid, malic acid, tartaric acid, ascorbic acid, fumaric acid, adipic acid.

19. Packing device (10) as in claim 1, wherein said storage chambers (11a, 11b) are in a controlled environment.

20. Packing device (10) as in claim 1 wherein said two storage chambers (11a, 11b) are made in a single sachet (23).

21. Packing device (10) as in claim 20, wherein said two storage chambers (11a, 11b) are separated by a transverse division or membrane (24) inside said sachet (23).

22. Packing device (10) as in claim 20, wherein it comprises a single sachet (23).

23. Packing device (10) as in claim 20, wherein it comprises two or more sachets (23) connected to each other by a tear line (21a).

24. Method to prepare an effervescent powder comprising one or more active principles (P) using storage chambers (11a, 11b) physically separated from each other, said method comprising making available a packing device as in claim 1, wherein in one storage chamber (11a) there is a powder comprising said active principles (P) and a first excipient (E1) for effervescence and in another storage chamber (11b) there is a powder comprising said active principles (P) and a second excipient (E2) for effervescence;
with the condition that when said first excipient (E1) has a basic nature, said second excipient (E2) has an acidic nature, or vice versa.

25. Method as in claim 24, wherein the ratio in weight between said excipient with an acidic nature and said excipient with a basic nature is comprised between 1.0 and 2.2.

26. Method as in claim 25, wherein the grain size of said powders contained in said storage chambers (11a, 11b) is comprised between 75 and 800 μm.

27. Method to prepare a solution comprising one or more active principles (P) using a packing device (10) with storage chambers (11a, 11b) physically separated from each other as in claim 1, wherein:
in one storage chamber (11a) there is a powder comprising said active principles (P) and a first excipient (E1) for effervescence;
in another storage chamber (11b) there is a powder comprising said active principles (P) and a second excipient (E2) for effervescence;
said method comprising:
opening said storage chambers (11a, 11b) and mixing in water the powders contained in said storage chambers (11a, 11b) with consequent development of effervescence due to the reaction between said first excipient (E1) and said second excipient (E2);
obtaining a solution of said active principles (P) in water suitable for oral administration.

28. Method for packaging an effervescent powder comprising one or more active ingredients (P), wherein said method provides to:
make available a poly-coupled polymer-metal material;
make closing welds defining a folding line around a longitudinal axis (Y) and delimiting two storage chambers (11a, 11b) physically separated from each other;
introduce into one storage chamber (11a) a powder comprising one or more active ingredients (P) and a first excipient (E1) for effervescence;
introduce into another storage chamber (11b) a powder comprising one or more active ingredients (P) and a second excipient (E2) for effervescence;
make a closing weld to close said two storage chambers (11a, 11b), obtaining a closed multi-chamber package.

29. Method to package an effervescent powder comprising one or more active principles (P), wherein said method provides to:
make available a pipe (22) made of poly-coupled polymer-metal material;
make a first lower transverse closing weld (13b) and a second central separation weld (13c) defining a folding line around a longitudinal axis (Y) delimiting two physically separated storage chambers (11a, 11b);
introduce into a storage chamber (11a) a powder comprising one or more active principles (P) and a first excipient (E1) for effervescence;
introduce into another storage chamber (11b) a powder comprising one or more active principles (P) and a second excipient (E2) for effervescence;
make a third upper transverse closing weld (13a) to close said two storage chambers (11a, 11b) and obtain a closed multi-chamber stick-pack.

30. Packaging method as in claim 28, wherein it comprises making a pre-cut (14) disposed along said longitudinal axis (Y) and transverse thereto, and configured to define a tear-off lead-in, to open said storage chambers (11a, 11b) along a tear line (20) transverse to said longitudinal axis (Y).

31. Method for packaging an effervescent powder comprising one or more active ingredients (P), wherein said method provides to:
make available a poly-coupled polymer-metal material and a division or membrane (24);
make closing welds to define at least one sachet (23) delimiting internally two storage chambers (11a, 11b) physically separated from each other by said division or membrane (24) transversely inside said sachet (23);
introduce into one storage chamber (11a) a powder comprising one or more active ingredients (P) and a first excipient (E1) for effervescence;
introduce into another storage chamber (11b) a powder comprising one or more active ingredients (P) and a second excipient (E2) for effervescence;
make a closing weld to close said two storage chambers (11a, 11b), obtaining a closed multi-chamber package.

32. Packing device (10) for the preparation and oral administration of a powder composition comprising one or more active principles (P), wherein said packing device (10) is provided with two storage chambers (11a, 11b) physically separated from each other, in which:
in one storage chamber (11a) a powder is packaged comprising one or more active ingredients (P) and a possible first excipient (E1);
in another storage chamber (11b) a powder is packaged comprising one or more active ingredients (P) and a possible second excipient (E2).

33. Packing device (10) for the preparation and oral administration of a powdered composition comprising one or more active principles (P), wherein said packing device (10) is a closed stick-pack having only three welds (13a, 13b, 13c) and formed by a pipe (22) made of poly-coupled polymer-metal material on which there are two transverse closing welds, upper (13a) and lower (13b), and a central separation weld (13c) defining a folding line (21) around a longitudinal axis (Y), said separation weld (13c) delimiting two storage chambers (11a, 11b) physically separated from each other, in which:
in one storage chamber (11a) a powder is packaged comprising one or more active principles (P) and a possible first excipient (E1);
in another storage chamber (11b) a powder is packaged comprising one or more active principles (P) and a possible second excipient (E2).

34. Packing device (10) as in claim 32, wherein said storage chambers (11a, 11b) are in a controlled atmosphere.

35. Packing device (10) as in claim 32, wherein it comprises closing welds defining a line of folding and/or tearing around a longitudinal axis (Y) and delimiting said two storage chambers (11a, 11b) physically separated from each other.

36. Packing device (10) as in claim 32, wherein said two storage chambers (11a, 11b) are made in a single sachet (23).

37. Packing device (10) as in claim 36, wherein said two storage chambers (11a, 11b) are separated by a transverse division or membrane (24) inside said sachet (23).

38. Packing device (10) as in claim 36, wherein it comprises a single sachet (23).

39. Packing device (10) as in claim 36 wherein it comprises two or more sachets (23) connected to each other by a tear line (21a).

40. Method for packaging a powder composition comprising one or more active principles (P), wherein said method provides to:
make available a polymer-metal polymeric material;
make closing welds defining a folding and/or tear line around a longitudinal axis (Y) and delimiting two storage chambers (11a, 11b) physically separated from each other;
introduce into one storage chamber (11a) a powder comprising one or more active principles (P) and a possible first excipient (E1);
introduce into another storage chamber (11b) a powder comprising one or more active principles (P) and a second excipient (E2);
make a closing weld to close said two storage chambers (11a, 11b), obtaining a closed multi-chamber package.

41. Method to package a powdered composition comprising one or more active principles (P), wherein said method provides to:
make available a pipe (22) of poly-coupled polymer-metal material;
make a first lower transverse closing weld (13b) and a second central separation weld (13c) defining a folding and/or tearing line around a longitudinal axis (Y) delimiting two physically separated storage chambers (11a, 11b);
introduce into a storage chamber (11a) a powder comprising one or more active principles (P) and a possible first excipient (E1);
introduce into another storage chamber (11b) a powder comprising one or more active principles (P) and a possible second excipient (E2);
make a third upper transverse closing weld (13a) to close said two storage chambers (11a, 11b) and obtain a closed multi-chamber stick-pack.

42. Method for packaging an effervescent powder comprising one or more active principles (P), wherein said method provides to:
make available a poly-coupled polymer-metal material and a division or membrane (24);
make closing welds to define at least one sachet (23) internally delimiting two storage chambers (11a, 11b) physically separated from each other by said division or membrane (24) transversely inside said sachet (23);
introduce into one storage chamber (11a) a powder comprising one or more active ingredients (P) and a first excipient (E1);
introduce into another storage chamber (11b) a powder comprising one or more active ingredients (P) and a second excipient (E2);
make a closing weld to close said two storage chambers (11a, 11b), obtaining a closed multi-chamber package.

43. Packaging method as in claim 40, wherein it comprises making a transverse pre-cut (14) configured to define a tear-off lead-in, to open said storage chambers (11a, 11b) along a transverse tear line (20).
